(19) United States
(12) Patent Application Publication
(10) Pub. No.: US 2013/0007598 A1
(43) Pub. Date: Jan. 3, 2013

(54) TECHNIQUES FOR APPLYING CULTURAL SETTINGS TO DOCUMENTS DURING LOCALIZATION

(75) Inventors: Jodie Draper, Kirkland, WA (US); Teruyuki Mihashi, North Bend, WA (US)

(73) Assignee: MICROSOFT CORPORATION, Redmond, WA (US)

(21) Appl. No.: 13/172,352

(22) Filed: Jun. 29, 2011

(51) Int. Cl. G06F 17/00

(52) U.S. Cl. 715/235

(57) ABSTRACT

Techniques for applying cultural settings to documents during localization are described. An apparatus may comprise a stylesheet generation component operative to generate a stylesheet from a configuration file, the configuration file specific to a formatting standard, the stylesheet comprising one or more conversion rules for the conversion of one or more documents to the formatting standard. Other embodiments are described and claimed.

### BACKGROUND

Localization is the process in which a document is modified for a particular locality. The most apparent part of localization is the translation of the contents of the document into the local language, but many documents additionally require formatting changes. For instance, some countries differ in the standard page size used, what fonts and font sizes are most readable, the proper format for dates, and other formatting or layout-based differences. Unfortunately, those with the required expertise for language translation may not have the expertise required for making formatting or layout changes, lacking either the knowledge of what changes need to be made or the technical expertise to make them. As such, existing localization tools that provide no or little assistance for these changes can be inconvenient and inefficient to use. It is with respect to these and other considerations that the present improvements have been needed.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

Various embodiments are generally directed to techniques for applying cultural settings to documents during localization. Some embodiments are particularly directed to techniques for generating a stylesheet from a configuration file, the configuration file specific to or containing standards for a particular formatting standard. In one embodiment, for example, an apparatus may comprise a stylesheet generation component operative on the logic device to generate a stylesheet from a configuration file, the configuration file specific to a formatting standard, the stylesheet comprising one or more conversion rules for the conversion of one or more documents to the formatting standard. Other embodiments are described and claimed.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates an embodiment of a localization system.

FIG. 2 illustrates an embodiment of a logic flow for the system of FIG. 1.

FIG. 3 illustrates an example localization of the formatting of a document.

FIG. 4 illustrates an embodiment of a centralized system for the system of FIG. 1.

FIG. 5 illustrates an embodiment of a distributed system for the system of FIG. 1.

FIG. 6 illustrates an embodiment of a computing architecture.

FIG. 7 illustrates an embodiment of a communications architecture.

### DETAILED DESCRIPTION

Various embodiments are directed to techniques for applying cultural settings to documents during localization. The localization of a document involves changing the contents and structure of that document in order to match the standards of a location. These standards may arise from particular national or regional expectations for how documents are read, and may correspond to the common practices for the creation of documents in that nation or region. These standards may also specify a particular language that should be used. However, a localization is not necessarily for a particular nation or language as many nations have inhabitants which speak different languages, and all language are spoken in more than one country. As such, a localization may be said to be for a particular culture, which combines the standards for a particular country or region with a language, commonly one spoke within that country or region. For example, many documents are created in the English language using American standards for formatting (e.g. letter sized pages and the use of the Daylight Savings Time format), and these documents could be said to be for the America/English culture. If this document is localized for the China/Chinese culture, the content would be translated to the Chinese language while the formatting standards would be modified to those use in China. If the document were localized for the America/Spanish culture, the content would be translated to the Spanish language, while many, though not necessarily all, of the formatting standards would remain the same—being common to all American publishing standards—would others might change—being adjusted for the use of the Spanish language. As such, we can see that a cultural localization comprises standards and changes which relate to both region and language.

The localization of a document can be divided into two distinct types of changes: language translation and formatting changes. In various embodiments, we define formatting to include all of the structural, style, display, or presentation elements which are not part of the textual content of the document. In various embodiments, we define formatting to be all elements of a document other than those which are subject to translation from one language to another. This division can be of value because the expertise necessary for the translation from one language to another is different from the expertise necessary to adjust the formatting. A translation expert may not be aware of the formatting standards for a particular culture and may not have the expertise necessary to adjust a document to meet those standards. In particular, some documents, such as the stored as XML or OpenXML, may require formatting changes that are especially difficult for those without technical expertise to make, as they may rely on settings precise values—such as a value corresponding to page size—which are represented as abstract numbers, and therefore require specific technical knowledge to adjust. As such, there may be considerable value in dividing localization into language translation and formatting changes, so that a translation expert can carry out the language translation while a technical expert carries out the formatting changes. Further, many of these formatting changes may be suitable for automation, such that an automatic computer process is able to apply the culture-specific standards to a document that is being localized.

The use of an automated computer process to apply the formatting standards can reduce the work required for the localization of a document, particularly when a large number of documents are going to be localized to the same culture, such as a in batch processing scenario. A company or organization may have a large number of documents that they wish to release or distribute in a particular region or in a particular language and while the contents of these documents may require individual translation for localization, the formatting changes may be able to be applied generally to all of the documents. As such, by specifying the formatting standard and allowing an automated process to apply the standard to the entire batch of documents, a considerable time savings can be achieved in the localization process. This may be especially useful when the documents being translated contain a high proportion of formatting data as compared to written content, such as is often the case for templates. A template may be a mostly-empty document containing formatting appropriate to a particular use or purpose, with all or a majority of the content being placeholder text indicating what type of content was intended to be placed at the location of the placeholder text. As placeholder text in a template is usually lesser in quantity than for a typical document, this may make the amount of time that would be required to manually localize the formatting of a template a much higher percentage of the total time required for localization than would be the case for a normal document. As such, the increase in efficiency by using an automated process to localize the formatting of a document is particularly high when that document is a template. This makes an computer-driven process of localization of particular value for localizing templates.

The use of stylesheets, such as a stylesheet written in the Extensible Stylesheet Language Transformations (XSLT) language, may be of considerable value in applying a formatting standard to a document or a batch of documents. In various embodiments, stylesheets allow for the application of rules to a document. For example, if a formatting standard specifies that an A4 page size should be used, a stylesheet enforcing that standard could have a rule specifying that the page size of a document should be set to A4. If the stylesheet were applied to one or more input documents, this rule would be uniformly enforced, such that the one or more output documents would all use the A4 page size. The creation of a stylesheet can itself be automated. For instance, in various embodiments, a stylesheet generation component may be operative to receive a configuration file, the configuration file specifying one or more settings defining a formatting standard, and generate a stylesheet from the configuration file, the stylesheet containing one or more conversion rules for the conversion of documents to the formatting standard as defined by the configuration file. In effect, a stylesheet generation component may convert a defined formatting standard into conversion rules which apply that standard to a document.

The generation of a stylesheet from a configuration file may be benefited by application-specific knowledge. For example, a configuration file may define a specific page size for use with a particular culture. However, the method of specifying a page size may differ between applications or types of documents. As such, there may be a benefit to using an application-specific file which contains partial or general document rules, not specific to a particular culture, for changing the formatting of a document. The conversion rules in the generated stylesheet may then comprise a synthesis of the document rules, which are specific to a type of document but general across all cultures, and the formatting standard defined in a configuration file, which is specific to a culture but general across all types of documents. For example, a partial document rule might specify which document attribute needs to be modified to use a particular font while the configuration file specifies which font should be used. The resulting synthesis of these would be a conversion rule that modifies the specified document attribute to be the specified font.

The rules of a stylesheet may be conditional in nature. For example, a stylesheet created for the localization of a document from a language read left-to-right to a language read right-to-left might specify that if an object is anchored to the left edge that it should be changed to be anchored to the right edge, while an object that is anchored to the right edge should be changed to be anchored to the left edge. The use of conditional rules in a stylesheet may be of particular value when the general rules for the localization of a document to a specified culture require corrections that are specific to a particular document. For example, as a general rule, the size of a font might not need to be changed when localizing a document from the America/English culture to the Germany/German culture. However, some particular documents might contain portions of text that are intended to be contained within a certain area of the document, and the change in language might result in that portion of text flowing outside the area, possibly due to a greater number of characters being used for the translated German text than were used for the English text. As such, these documents might be benefited by a rule specifying that for those specific documents the font size for that specific text should be adjusted. In various embodiments, we might refer to this as a correction rule, where a correction rule is a rule for a change in formatting specific to one or more documents, but not generally applicable to all documents.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives falling within the spirit and scope of the claimed subject matter.

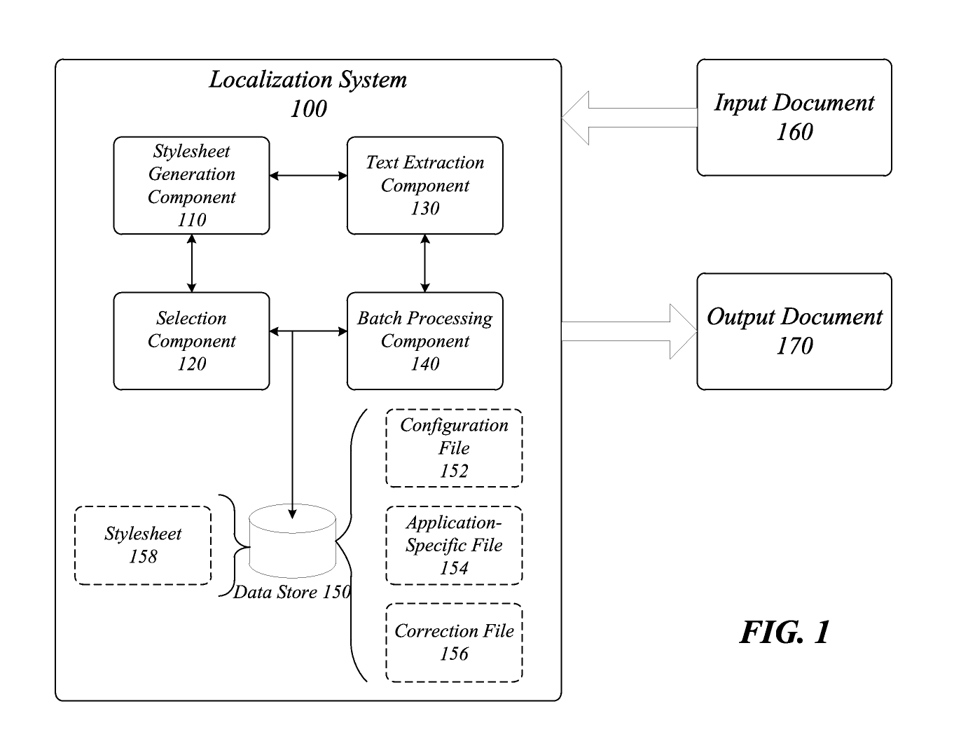

FIG. 1 illustrates a block diagram for a localization system 100. In one embodiment, the localization system 100 may comprise a computer-implemented localization system 100 having one or more software applications and/or components. Although the localization system 100 shown in FIG. 1 has a limited number of elements in a certain topology, it may be appreciated that the localization system 100 may include more or less elements in alternate topologies as desired for a given implementation.

In the illustrated embodiment shown in FIG. 1, the localization system 100 includes a stylesheet generation component 110, a selection component 120, a text extraction component 130, a batch processing component 140, and a data store 150. The stylesheet generation component 110 is generally operative to generate a stylesheet 158 from a configuration file 152, from a configuration file 152 and an application-specific file 154, from a configuration file 152 and a correction file 156, or from a configuration file 152, an application-specific file 154, and a correction file 156. The selection component 120 is generally operative to select the configuration file 152 from a plurality of configuration files stored on data store 150. The text extraction component 130 is generally operative to extract text from the one or more documents, such as input document 170, for translation to a language corresponding to a particular culture. The batch processing component 140 is generally operative to iteratively apply the stylesheet 158 to a plurality of documents, such as by applying the stylesheet 158 to input document 160 to produce output document 170.

In various embodiments, the stylesheet generation component 110 may be operative to generate a stylesheet 158 from a configuration file 152. The configuration file 152 may be specific to a formatting standard. The generated stylesheet 158 may therefore comprise one or more conversion rules for the conversion of one or more documents to the formatting standard as defined in the configuration file 152. In various embodiments, the configuration file may comprise one or more settings defining the formatting standard. These settings may be one or more of font or typeface, font or type size, font or type style (e.g. boldface, italics, underlining, strikethrough, outline, color, superscript, and subscript), justification (e.g. left, right, center, justify, force justify), tab stop position, indentation position, leading, kerning, tracking, letter case, page size, page height, page width, margin size (e.g. left, right, top, and bottom margin size and header and footer margin size), date format (e.g. MM/DD/YY and DD/MM/YY), time format, calendar type (e.g. Hijiri and Gregorian), and reading direction (e.g. left-to-right and right-to-left). It will be appreciated that these represent only specific examples of formatting settings defining a formatting standard, and that in various embodiment any setting which isn't the textual content of a document may correspond to a formatting setting within a formatting standard.

In various embodiments, the stylesheet generation component 110 may be operative to generate the stylesheet 158 from a configuration file 152 and an application-specific file 154. The application-specific file 154 may comprise one or more document rules specific to the translation of a particular type of document. A type of document may correspond to a particular type of application used to generate documents and may correspond to a document stored in a particular format. The generated stylesheet 158 may therefore comprise one or more generated conversion rules comprising a synthesis of one or more of the document rules and one or more of the settings defining the formatting standard. The application-specific file 154 may be an application-specific stylesheet written in a manner general to culture and contain references to what information from a culture-specific configuration file 152 is to be used in creating conversion rules which are specific to both the type of document and the culture. Thus, once the culture for localization is known and the appropriate configuration file 152 is determined, the formatting standard information from the configuration file 152 may combined or synthesized with the document rules from the application-specific file 154 to produce the conversion rules within the stylesheet 158. As such, the stylesheet 158 may comprise the application-specific stylesheet modified to incorporate the formatting standard information from a configuration file 152 into the document rules within the application-specific stylesheet.

In various embodiments, the stylesheet generation component 110 may be operative to generate the stylesheet 158 from a configuration file 152 and a correction file 156. The correction file 156 may comprise one or more correction rules specific to the translation of a particular document of one or more documents. The correction file 156 may comprise one or more correction rules specific to the translation of a particular subset of the one or more documents. The correction rules however, would not be generally applicable to all of the one or more documents. A correction rule may comprise any rule specific to both a type of document and a culture which is not generally applicable to all documents of the one or more documents. A correction rule may comprise a conditional rule, wherein the condition specifies one or more specific documents to which the correction contained within the rule should be applied. This specification of a document may comprise a document name, a file number, or any method of specifying a particular document. In various embodiments, the correction file may comprise a correction stylesheet, the correction stylesheet containing the correction rules. The conversion rules within the stylesheet 158 may therefore contain as a subset of those conversion rules the correction rules from a correction stylesheet. The conversion rules within the stylesheet 158 may therefore comprise a combination or concatenation of rules generated from the configuration file 152 and the correction rules contained within the correction file 156.

In various embodiments, the stylesheet generation component 110 may be operative to generate the stylesheet 158 from the configuration file 152, the application-specific file 154, and the correction file 156. It will be appreciated that the technique for generating conversion rules from the configuration file 152 and the application-specific file 154 may be combined, in sequence or in parallel, with the technique for generation conversion rules from the configuration file 152 and the correction file 156. The conversion rules within the stylesheet 158 may therefore comprise a synthesis of the formatting standard information from the configuration file 152 and the document rules from the application-specific file 154 concatenated with the correction rules from the correction file 156. That is, document rules from the application-specific file 154 may be combined with the formatting standard information from the configuration file 152 to generate a first portion of the conversion rules, with the second portion of the conversion rules being correction rules from the correction file 156, these combined portions of conversion rules being the full set of conversion rules within the stylesheet 158.

In various embodiments, the selection component 120 may be operative to select the configuration file 152 from a plurality of configuration files. The plurality of configuration files may each be specific to a particular formatting standard, where each formatting standard corresponds to a particular culture, with the configuration file 152 selected as being the formatting standard for the particular culture being localized for. As such, the selection component 120 may be operative to select the configuration file 152 as being the configuration file corresponding to a particular culture. The selection component 120 may be operative to pass the selected configuration file 152 to the stylesheet generation component 110 for use in the generation of stylesheet 158. The selection component 120 may be operative to examine a plurality of configuration files stored on a data store, such as data store 150, to determine which configuration file should be used. The selection component 120 may be operative to examine an index or table of configuration files, the index or table indicating an association between a particular culture and a particular configuration file, to determine which configuration file should be used.

In various embodiments, the selection component 120 may be operative to select the application-specific file 152 from a plurality of application-specific files. The plurality of application-specific files may each specific to a particular type of document, the application-specific file 154 selected as corresponding to the type of document being localized. As such, the selection component 120 may be operative to select the application-specific file 154 as being the application-specific file corresponding to an input document 160. The selection component 120 may be operative to pass the selected application-specific file 152 to the stylesheet generation component 110 for use in the generation of stylesheet 158. The selection component 120 may be operative to examine a plurality of application-specific files stored on a data store, such as data store 150, to determine which application-specific file should be used. The selection component 120 may be operative to examine an index or table of application-specific files, the index or table indicating an association between a particular culture and a particular application-specific file, to determine which configuration file should be used. This index or table may be the same index or table indicating associations between particular cultures and particular configuration files or may be a separate index or table of associations.

In various embodiments, the text extraction component 130 may be operative to extract text from the one or more documents, such as input document 160, for translation to a language corresponding to a particular culture, the text extraction component operative to ignore attributes of the one or more documents that the stylesheet generation component 110 is operative to convert. For instance, a document may contain content in the form of text, with that text having associated with it various formatting attributes. The text extraction component 130 may be operative to extract this text while not extracting the formatting attributes. In various embodiments, the extracted text may be presented for translation, such as by a language translation expert. This translated text may be incorporated into the localized document such that output document 170 comprises a document localized in both formatting and language.

In various embodiments, batch processing component 140 may be operative to iteratively apply the stylesheet 158 to a plurality of documents. Batch processing component 140 may be operative to apply the stylesheet 158 to input document 160 to produce output document 170. In various embodiments, input document 160 may be one of a plurality of input documents, each of which is to be localized to a particular culture. In various embodiments, the plurality of input documents may comprise a plurality of templates. If the plurality of documents are all to be localized to the same culture, the batch processing component 140 may be operative to instruct the stylesheet generation component 110 to generate the stylesheet 158 for that particular culture. If the plurality of documents are to be localized to a plurality of cultures, the batch processing component 140 may be operative to instruct the stylesheet generation component 110 to generate a plurality of stylesheet for the plurality of cultures, each stylesheet corresponding to a particular culture to be localized for. If the plurality of documents to be localized are all of the same type of document, the batch processing component 140 may be operative to instruct the stylesheet generation component 110 to generate the stylesheet 158 for that particular type of document. If the plurality of documents are of a plurality of types, the batch processing component 140 may be operative to instruct the stylesheet generation component to generate a plurality of stylesheet from a plurality of document types, each stylesheet corresponding to a particular type of document to be localized. If the plurality of documents are to be localized for a plurality of cultures and comprise a plurality of document types, the batch processing component 140 may be operative to instruct the stylesheet generation component 110 to generate a plurality of stylesheets such that a stylesheet corresponding to each pair of cultures and document types is generated. If a plurality of stylesheets is generated and used, the batch processing component 140 may be operative to iteratively apply the appropriate stylesheet of the plurality of stylesheets to each document in the plurality of documents. This application may comprise, for each document in the plurality of documents, identifying the culture and document type of that document, selecting the stylesheet corresponding to that culture and document type, and then applying the selected stylesheet to the document.

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be needed for a novel implementation.

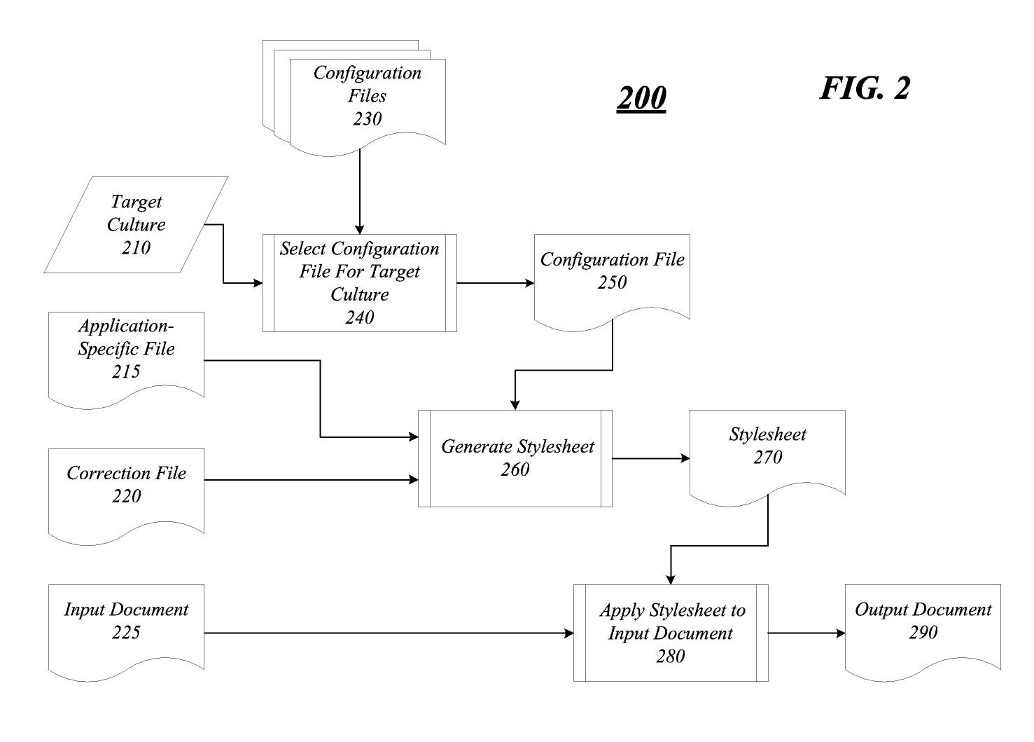

FIG. 2 illustrates one embodiment of a logic flow 200. The logic flow 200 may be representative of some or all of the operations executed by one or more embodiments described herein.

The operations recited in logic flow 200 may be embodied as computer-readable and computer-executable instructions that reside, for example, in data storage features such as a computer usable volatile memory, a computer usable non-volatile memory, and/or data storage unit. The computer-readable and computer-executable instructions may be used to control or operate in conjunction with, for example, a processor and/or processors. Although the specific operations disclosed in logic flow 200 may be embodied as such instructions, such operations are exemplary. That is, the instructions may be well suited to performing various other operations or variations of the operations recited in logic flow 200. It is appreciated that instructions embodying the operations in logic flow 200 may be performed in an order different than presented, and that not all of the operations in logic flow 200 may be performed.

In operation 240, a configuration file 250 is selected from a plurality of configuration files 230. The plurality of configuration files 230 may each be specific to a particular formatting standard, where each formatting standard corresponds to a particular culture, with the configuration file 250 selected as being the formatting standard for the particular culture being localized for. As such, the configuration file 250 may be selected as being the configuration file corresponding to a particular culture. The selected configuration file 250 is to be used in the generation of stylesheet 270. The selection of configuration file 250 may involve the examination of a plurality of configuration files 230 stored on a data store to determine which configuration file should be used. The selection of configuration file 250 may involve the examination of an index or table of configuration files, the index or table indicating an association between a particular culture and a particular configuration file, to determine which configuration file should be used.

In operation 260, a stylesheet 270 is generated. In various embodiments, the stylesheet may be generated from the selected configuration file 250. The configuration file 250 may be specific to a formatting standard. The generated stylesheet 270 may therefore comprise one or more conversion rules for the conversion of one or more documents to the formatting standard as defined in the configuration file 250. In various embodiments, the configuration file may comprise one or more settings defining the formatting standard. These settings may be one or more of font or typeface, font or type size, font or type style (e.g. boldface, italics, underlining, strikethrough, outline, color, superscript, and subscript), justification (e.g. left, right, center, justify, force justify), tab stop position, indentation position, leading, kerning, tracking, letter case, page size, page height, page width, margin size (e.g. left, right, top, and bottom margin size and header and footer margin size), date format (e.g. MM/DD/YY and DD/MM/YY), time format, calendar type (e.g. Hijiri and Gregorian), and reading direction (e.g. left-to-right and right-to-left). It will be appreciated that these represent only specific examples of formatting settings defining a formatting standard, and that in various embodiment any setting which isn't the content or textual content of a document may correspond to a formatting setting within a formatting standard.

In various embodiments, the stylesheet 270 may be generated from a configuration file 250 and an application-specific file 215. The application-specific file 215 may comprise one or more document rules specific to the translation of a particular type or format of document. The generated stylesheet 260 may therefore comprise one or more generated conversion rules comprising a synthesis of one or more of the document rules and one or more of the settings defining the formatting standard. The application-specific file 215 may be an application-specific stylesheet written in a manner general to culture and contain references to what information from a culture-specific configuration file 250 is to be used in creating conversion rules which are specific to both the type of document and the culture. Thus, once the culture for localization is known and the appropriate configuration file 250 is determined, the formatting standard information from the configuration file 250 may combined or synthesized with the document rules from the application-specific file 215 to produce the conversion rules within the stylesheet 270. As such, the stylesheet 270 may comprise an application-specific stylesheet modified to incorporate the formatting standard information from a configuration file 250 into the document rules within the application-specific stylesheet.

In various embodiments, the stylesheet 270 may be generated from a configuration file 250 and a correction file 220. The correction file 220 may comprise one or more correction rules specific to the translation of a particular document of one or more documents. The correction file 220 may comprise one or more correction rules specific to the translation of a particular subset of the one or more documents. The correction rules however, would not be generally applicable to all of the one or more documents. A correction rule may comprise any rule specific to both a type of document and a culture which is not generally applicable to all documents of the one or more documents. A correction rule may comprise a conditional rule, wherein the condition specifies one or more specific documents to which the correction contained within the rule should be applied. This specification of a document may comprise a document name, a file number, or any method of specifying a particular document. In various embodiments, the correction file may comprise a correction stylesheet, the correction stylesheet containing the correction rules. The conversion rules within the stylesheet 270 may therefore contain as a subset of those conversion rules the correction rules from a correction stylesheet. The conversion rules within the stylesheet 270 may therefore comprise a combination or concatenation of rules generated from the configuration file 230 and the correction rules contained within the correction file 215.

In various embodiments, the stylesheet 270 may be generated from a configuration file 250, an application-specific file 215, and the correction file 220. It will be appreciated that the technique for generating conversion rules from the configuration file 250 and the application-specific file 215 may be combined, in sequence or in parallel, with the technique for generation conversion rules from the configuration file 250 and the correction file 220. The conversion rules within the stylesheet 270 may therefore comprise a synthesis of the formatting standard information from the configuration file 250 and the document rules from the application-specific file 215 concatenated with the correction rules from the correction file 220. That is, document rules from the application-specific file 215 may be combined with the formatting standard information from the configuration file 250 to generate a first portion of the conversion rules, with the second portion of the conversion rules being correction rules from the correction file 220, these combined portions of conversion rules being the full set of conversion rules within the stylesheet 270.

In operation 280, the stylesheet is applied to an input document 225 to produce an output document 290. This application may comprise any of the known techniques for the application of a stylesheet to a document.

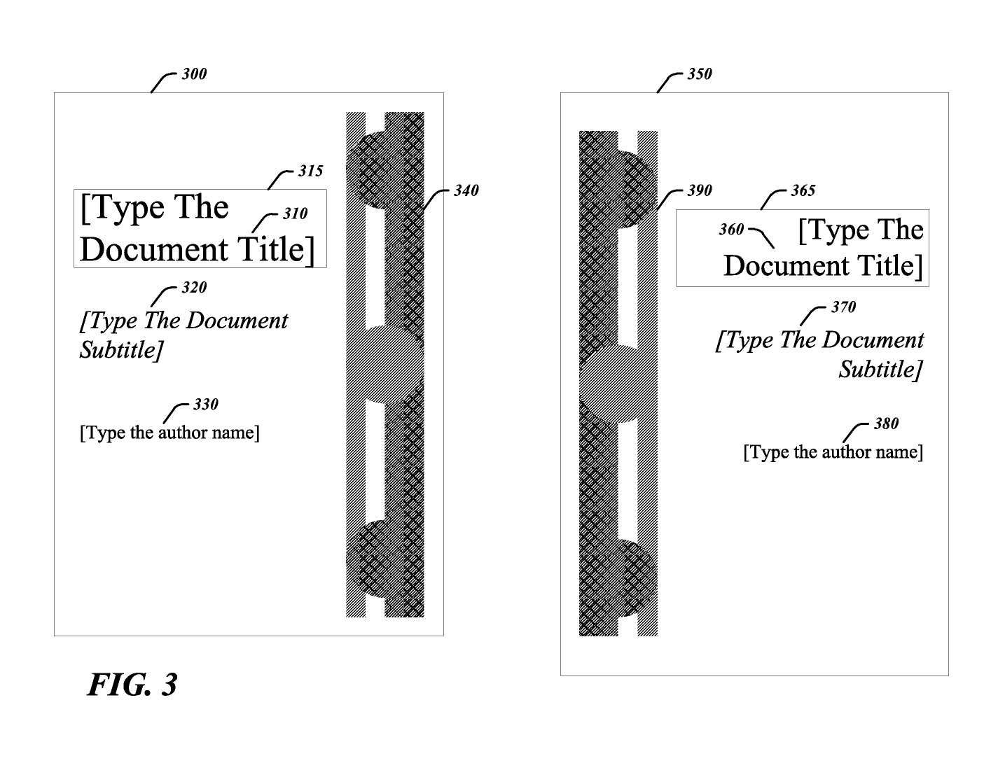

FIG. 3 illustrates an example change of formatting as might be applied during a localization process. Document 300 provides an example of a template document before localization formatting changes have been applied and document 350 provides an example of the same template document after localization formatting changes have been applied. It should be noted that the changes as represented by this example represent only a subset of the possible changes that can be made during the localization process.

As can be seen in FIG. 3, the page size of document 300 was changed in producing document 350. In various embodiments, this would correspond to the formatting standard specifying in the configuration file 250, with reference to FIG. 2, that the target culture uses a page size as depicted by document 350 in FIG. 3. The application-specific file 215 would have contained a document rule defining how to adjust the page size of a document of the type of document 300. The synthesis of configuration file 250 and application-specific file 215 would have produced a stylesheet 270 with a conversion rule for adjusting the page size. When applied to the document 300, this would produce document 350 with the specified page size.

In FIG. 3, elements 310, 320, and 330, and the corresponding elements 360, 370, and 380 represent the textual content of a template cover page of a template document. As such, during the localization process, the text 310, 320, and 330 (alternatively but similarly the text 360, 370, and 380) would be translated, such as by a translation expert, into the language of the culture into which the document is being localized. However, as can be seen in FIG. 3, the location and formatting of elements 310, 320, and 330 has been changed in applying conversion rules to produce elements 360, 370, and 380. In this example, the culture being localized for uses a right-to-left reading direction, while the source culture of the document uses a left-to-right reading direction, as in English. As such, each of 360, 370, and 380 are right-justified and are attached to the right margin of the page, as source elements 310, 320, and 330 were left-justified and were attached to the left margin of the page. In various embodiments, this would correspond to the formatting standard specifying in the configuration file 250 that the target culture uses a right-to-left reading direction. The application-specific file 215 may have contained a plurality of document rules defining how to adjust the reading direction of a document of the type of document 300. The synthesis of configuration file 250 and application-specific file 215 would have produced a stylesheet 270 with conversion rules for adjusting the location and justification of textual elements, such as elements 310, 320, and 330. When applied to the document 300, this would produce document 350 in which elements 360, 370, and 380 are appropriately positioned and justified for a right-to-left reading direction.

Similarly, the non-text content of the page was adjusted according to the change in reading direction. Graphic 340, which was attached to the right margin of page 300 was horizontally mirrored and attached to the left margin of the page. Box 315, which provided a box around element 310, the title, has been moved from being attached to the left-margin to being attached to the right-margin. Again, in various embodiments, this would correspond to the formatting standard specifying in the configuration file 250 that the target culture uses a right-to-left reading direction, with the synthesis of configuration file 250 and application-specific file 215 producing a stylesheet 270 with conversion rules for adjusting the location and justification of non-textual elements, such as elements 315 and 340. When applied to the document 300, this would produce document 350 in which elements 365 and 390 are appropriately positioned and justified for a right-to-left reading direction.

Of note in FIG. 3 is that the font size of element 360 has been changed. In various embodiments, this may correspond to the application of a correction rule to element 310 of document 300. In this example, it may be the case that the translation of the text “[Type The Document Title]” into the language of the target culture would produce text too large for the box 315. In that case, a correction rule would be specified in correction file 220 specifying that for this particular document that a smaller font size should be used for the text “[Type The Document Title].” This rule would not be generally applied to the elements of document 300, but instead only to element 310, producing element 360. As can be seen in the example of FIG. 3, the font size of text elements 320 and 330 has not been changed in producing text elements 370 and 380.

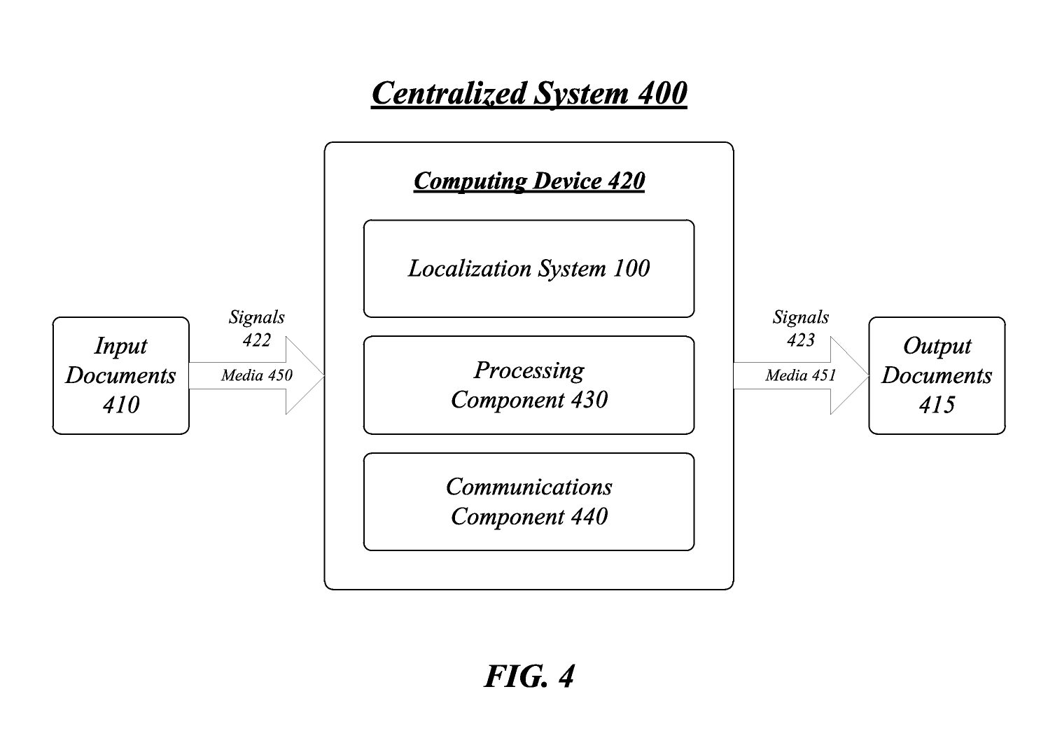

FIG. 4 illustrates a block diagram of a centralized system 400. The centralized system 400 may implement some or all of the structure and/or operations for the localization system 100 in a single computing entity, such as entirely within a single computing device 420. In one embodiment, the computing device 420 may be implemented as a server for a network. The embodiments are not limited in this context.

The computing device 420 may execute processing operations or logic for the localization system 100 using a processing component 430. The processing component 430 may comprise various hardware elements, software elements, or a combination of both. Examples of hardware elements may include devices, components, processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

The computing device 420 may execute communications operations or logic for the localization system 100 using communications component 440. The communications component 440 may implement any well-known communications techniques and protocols, such as techniques suitable for use with packet-switched networks (e.g., public networks such as the Internet, private networks such as an enterprise intranet, and so forth), circuit-switched networks (e.g., the public switched telephone network), or a combination of packet-switched networks and circuit-switched networks (with suitable gateways and translators). The communications component 440 may include various types of standard communication elements, such as one or more communications interfaces, network interfaces, network interface cards (NIC), radios, wireless transmitters/receivers (transceivers), wired and/or wireless communication media, physical connectors, and so forth. By way of example, and not limitation, communication media 450 includes wired communications media and wireless communications media. Examples of wired communications media may include a wire, cable, metal leads, printed circuit boards (PCB), backplanes, switch fabrics, semiconductor material, twisted-pair wire, co-axial cable, fiber optics, a propagated signal, and so forth. Examples of wireless communications media may include acoustic, radio-frequency (RF) spectrum, infrared and other wireless media 450.

The computing device 420 may receive input documents 410 over a communications media 450 using communications signals 422 via the communications component 440. In various embodiments, and in reference to FIG. 1, input documents 410 may comprise input document 160 and output documents 415 may comprise output document 170. In various embodiments, and in reference to FIG. 2, input documents 410 may comprise input document 225 and output documents 415 may comprise output document 290.

In various embodiments, and in reference to FIG. 1, processing component 430 may comprise all or some of stylesheet generation component 110, selection component 120, text extraction component 130, and batch processing component 140. In reference to FIG. 2, processing component 430 may be operative, in conjunction with communications component 440, to carry out operations 240, 260, and 280. In reference to FIG. 3, processing component 430 may be operative, in conjunction with communication component 440, to carry out the localization of document 300 into document 350. In various embodiments, output documents 415 may comprise fully localized documents, localized in both formatting and language. In various embodiments, output documents 415 may comprise partially localized documents, localized in formatting but not in language. As such, output documents 415 may comprise partially localized documents awaiting language translation.

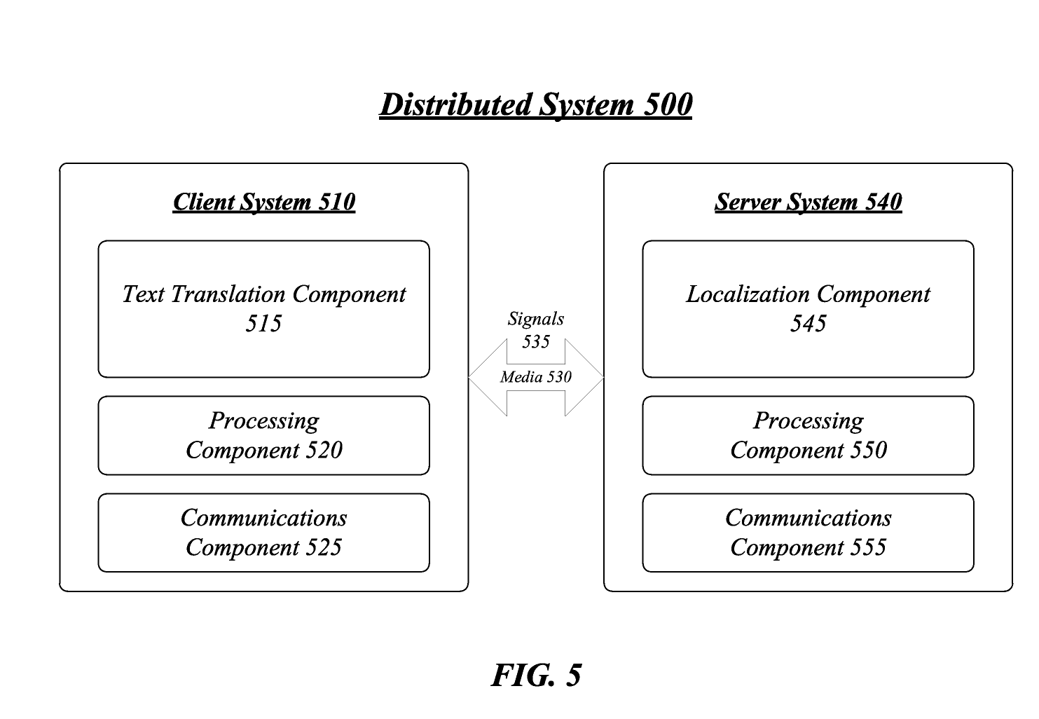

FIG. 5 illustrates a block diagram of a distributed system 500. The distributed system 500 may distribute portions of the structure and/or operations for the system 100 across multiple computing entities. Examples of distributed system 500 may include without limitation a client-server architecture, a 3-tier architecture, an N-tier architecture, a tightly-coupled or clustered architecture, a peer-to-peer architecture, a master-slave architecture, a shared database architecture, and other types of distributed systems. The embodiments are not limited in this context.

The client system 510 and the server system 540 may process information using the processing components 520 and 550, which are similar to the processing component 430 described with reference to FIG. 4. The client system 510 and the server system 540 may communicate with each over a communications media 530 using communications signals 535 via communications components 525 and 55, which are similar to the communications component 440 described with reference to FIG. 4.

In one embodiment, for example, the distributed system 500 may be implemented as a client-server system. A client system 510 may implement a text translation component 515 for use by a translation expert for translating text from one language into another and may implement text extraction component 130. A server system 540 may implement the stylesheet generation component 110, selection component 120, and batch processing component 140. In this embodiment, server system 540 would be operative, using localization component 545, to provide to the client system 510 one or more output documents for translation by the translation expert. In this embodiment, the output documents of server system 540 would comprise documents which have been localized to apply the formatting standard of the target culture, but for which the translation to the language of the target culture is still pending. Text translation component 515 would then be operative to provide to a translation expert, such as via a user interface on client system 510, the textual content of a document being localized for translation by the expert, as extracted by text extraction component 130.

In various embodiments, the client system 510 may comprise or employ one or more client computing devices and/or client programs that operate to perform various methodologies in accordance with the described embodiments.

In various embodiments, the server system 540 may comprise or employ one or more server computing devices and/or server programs that operate to perform various methodologies in accordance with the described embodiments. For example, when installed and/or deployed, a server program may support one or more server roles of the server computing device for providing certain services and features. Exemplary server systems 540 may include, for example, stand-alone and enterprise-class server computers operating a server OS such as a MICROSOFT® OS, a UNIX® OS, a LINUX® OS, or other suitable server-based OS. Exemplary server programs may include, for example, communications server programs such as Microsoft® Office Communications Server (OCS) for managing incoming and outgoing messages, messaging server programs such as Microsoft® Exchange Server for providing unified messaging (UM) for e-mail, voicemail, VoIP, instant messaging (IM), group IM, enhanced presence, and audio-video conferencing, and/or other types of programs, applications, or services in accordance with the described embodiments.

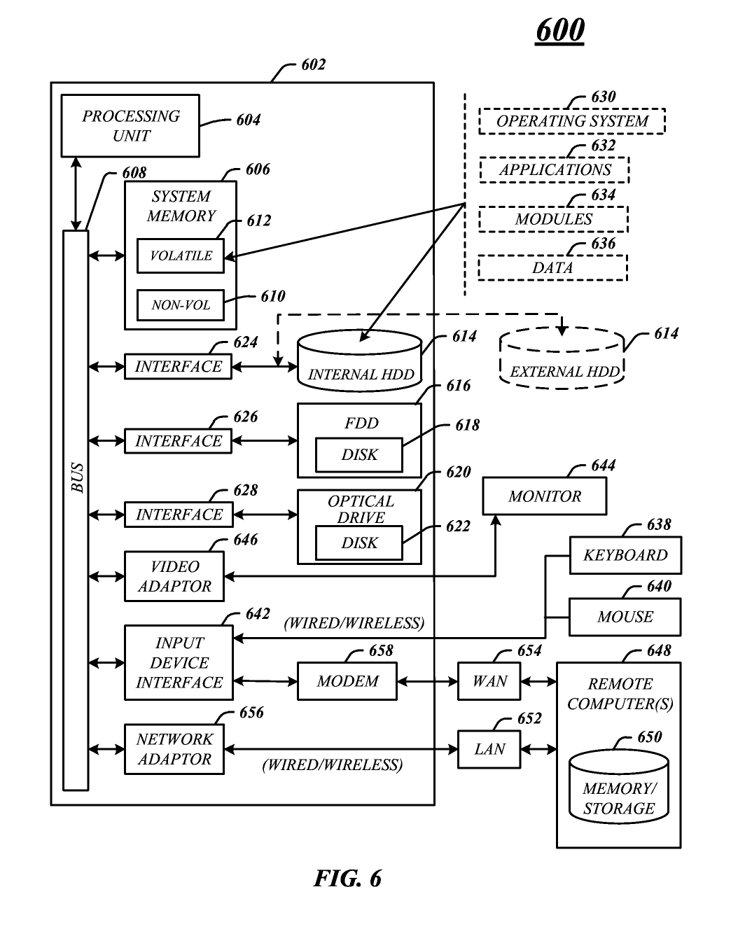

FIG. 6 illustrates an embodiment of an exemplary computing architecture 600 suitable for implementing various embodiments as previously described. As used in this application, the terms “system” and “component” are intended to refer to a computer-related entity, either hardware, a combination of hardware and software, software, or software in execution, examples of which are provided by the exemplary computing architecture 600. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

In one embodiment, the computing architecture 600 may comprise or be implemented as part of an electronic device. Examples of an electronic device may include without limitation a mobile device, a personal digital assistant, a mobile computing device, a smart phone, a cellular telephone, a handset, a one-way pager, a two-way pager, a messaging device, a computer, a personal computer (PC), a desktop computer, a laptop computer, a notebook computer, a handheld computer, a tablet computer, a server, a server array or server farm, a web server, a network server, an Internet server, a work station, a mini-computer, a main frame computer, a supercomputer, a network appliance, a web appliance, a distributed computing system, multiprocessor systems, processor-based systems, consumer electronics, programmable consumer electronics, television, digital television, set top box, wireless access point, base station, subscriber station, mobile subscriber center, radio network controller, router, hub, gateway, bridge, switch, machine, or combination thereof. The embodiments are not limited in this context.

The computing architecture 600 includes various common computing elements, such as one or more processors, co-processors, memory units, chipsets, controllers, peripherals, interfaces, oscillators, timing devices, video cards, audio cards, multimedia input/output (I/O) components, and so forth. The embodiments, however, are not limited to implementation by the computing architecture 600.

As shown in FIG. 6, the computing architecture 600 comprises a processing unit 604, a system memory 606 and a system bus 608. The processing unit 604 can be any of various commercially available processors. Dual microprocessors and other multi-processor architectures may also be employed as the processing unit 604. The system bus 608 provides an interface for system components including, but not limited to, the system memory 606 to the processing unit 604. The system bus 608 can be any of several types of bus structure that may further interconnect to a memory bus (with or without a memory controller), a peripheral bus, and a local bus using any of a variety of commercially available bus architectures.

The computing architecture 600 may comprise or implement various articles of manufacture. An article of manufacture may comprise a computer-readable storage medium to store logic. Examples of a computer-readable storage medium may include any tangible media capable of storing electronic data, including volatile memory or non-volatile memory, removable or non-removable memory, erasable or non-erasable memory, writeable or re-writeable memory, and so forth. Examples of logic may include executable computer program instructions implemented using any suitable type of code, such as source code, compiled code, interpreted code, executable code, static code, dynamic code, object-oriented code, visual code, and the like.

The system memory 606 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, or any other type of media suitable for storing information. In the illustrated embodiment shown in FIG. 6, the system memory 606 can include non-volatile memory 610 and/or volatile memory 612. A basic input/output system (BIOS) can be stored in the non-volatile memory 610.

The computer 602 may include various types of computer-readable storage media in the form of one or more lower speed memory units, including an internal hard disk drive (HDD) 614, a magnetic floppy disk drive (FDD) 616 to read from or write to a removable magnetic disk 618, and an optical disk drive 620 to read from or write to a removable optical disk 622 (e.g., a CD-ROM or DVD). The HDD 614, FDD 616 and optical disk drive 620 can be connected to the system bus 608 by a HDD interface 624, an FDD interface 626 and an optical drive interface 628, respectively. The HDD interface 624 for external drive implementations can include at least one or both of Universal Serial Bus (USB) and IEEE 1394 interface technologies.

The drives and associated computer-readable media provide volatile and/or nonvolatile storage of data, data structures, computer-executable instructions, and so forth. For example, a number of program components can be stored in the drives and memory units 610, 612, including an operating system 630, one or more application programs 632, other program components 634, and program data 636.

The one or more application programs 632, other program components 634, and program data 636 can include, for example, stylesheet generation component 110, selection component 120, text extraction component 130, and batch processing component 140.

A user can enter commands and information into the computer 602 through one or more wire/wireless input devices, for example, a keyboard 638 and a pointing device, such as a mouse 640. Other input devices may include a microphone, an infra-red (IR) remote control, a joystick, a game pad, a stylus pen, touch screen, or the like. These and other input devices are often connected to the processing unit 604 through an input device interface 642 that is coupled to the system bus 608, but can be connected by other interfaces such as a parallel port, IEEE 1394 serial port, a game port, a USB port, an IR interface, and so forth.

A monitor 644 or other type of display device is also connected to the system bus 608 via an interface, such as a video adaptor 646. In addition to the monitor 644, a computer typically includes other peripheral output devices, such as speakers, printers, and so forth.

The computer 602 may operate in a networked environment using logical connections via wire and/or wireless communications to one or more remote computers, such as a remote computer 648. The remote computer 648 can be a workstation, a server computer, a router, a personal computer, portable computer, microprocessor-based entertainment appliance, a peer device or other common network node, and typically includes many or all of the elements described relative to the computer 602, although, for purposes of brevity, only a memory/storage device 650 is illustrated. The logical connections depicted include wire/wireless connectivity to a local area network (LAN) 652 and/or larger networks, for example, a wide area network (WAN) 654. Such LAN and WAN networking environments are commonplace in offices and companies, and facilitate enterprise-wide computer networks, such as intranets, all of which may connect to a global communications network, for example, the Internet.

When used in a LAN networking environment, the computer 602 is connected to the LAN 652 through a wire and/or wireless communication network interface or adaptor 656. The adaptor 656 can facilitate wire and/or wireless communications to the LAN 652, which may also include a wireless access point disposed thereon for communicating with the wireless functionality of the adaptor 656.

When used in a WAN networking environment, the computer 602 can include a modem 658, or is connected to a communications server on the WAN 654, or has other means for establishing communications over the WAN 654, such as by way of the Internet. The modem 658, which can be internal or external and a wire and/or wireless device, connects to the system bus 608 via the input device interface 642. In a networked environment, program components or modules depicted relative to the computer 602, or portions thereof, can be stored in the remote memory/storage device 650. It will be appreciated that the network connections shown are exemplary and other means of establishing a communications link between the computers can be used.

The computer 602 is operable to communicate with wire and wireless devices or entities using the IEEE 802 family of standards, such as wireless devices operatively disposed in wireless communication (e.g., IEEE 802.11 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi (or Wireless Fidelity), WiMax, and Bluetooth™ wireless technologies. Thus, the communication can be a predefined structure as with a conventional network or simply an ad hoc communication between at least two devices. Wi-Fi networks use radio technologies called IEEE 802.11x (a, b, g, n, etc.) to provide secure, reliable, fast wireless connectivity. A Wi-Fi network can be used to connect computers to each other, to the Internet, and to wire networks (which use IEEE 802.3-related media and functions).

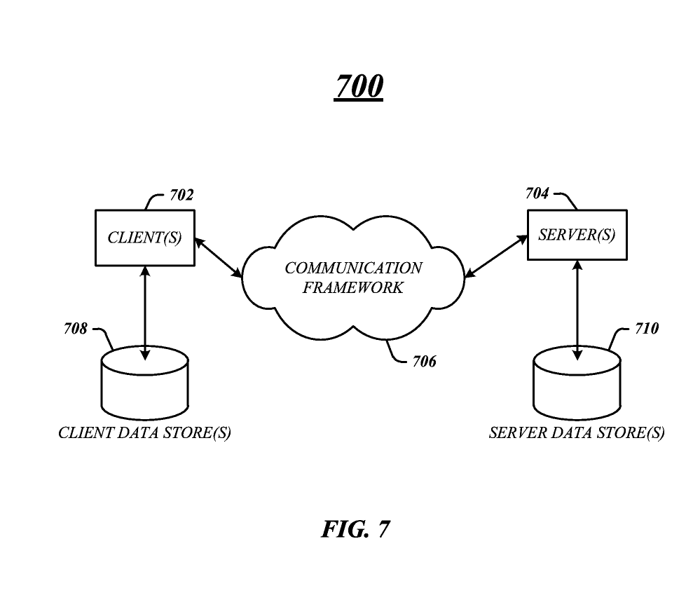

FIG. 7 illustrates a block diagram of an exemplary communications architecture 700 suitable for implementing various embodiments as previously described. The communications architecture 700 includes various common communications elements, such as a transmitter, receiver, transceiver, radio, network interface, baseband processor, antenna, amplifiers, filters, and so forth. The embodiments, however, are not limited to implementation by the communications architecture 700.

As shown in FIG. 7, the communications architecture 700 comprises includes one or more clients 702 and servers 704. The clients 702 may implement the client system 510. The servers 704 may implement the server system 540. The clients 702 and the servers 704 are operatively connected to one or more respective client data stores 708 and server data stores 710 that can be employed to store information local to the respective clients 702 and servers 704, such as cookies and/or associated contextual information.

The clients 702 and the servers 704 may communicate information between each other using a communication framework 706. The communications framework 706 may implement any well-known communications techniques and protocols, such as those described with reference to system 100. The communications framework 706 may be implemented as a packet-switched network (e.g., public networks such as the Internet, private networks such as an enterprise intranet, and so forth), a circuit-switched network (e.g., the public switched telephone network), or a combination of a packet-switched network and a circuit-switched network (with suitable gateways and translators).

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Further, some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

It is emphasized that the Abstract of the Disclosure is provided to allow a reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims.

1. An apparatus, comprising:
a logic device; and
a stylesheet generation component operative on the logic device to generate a stylesheet from a configuration file, the configuration file specific to a formatting standard, the stylesheet comprising one or more conversion rules for the conversion of one or more documents to the formatting standard.

2. The apparatus of claim 1, the configuration file comprising one or more settings defining the formatting standard.

3. The apparatus of claim 2, the stylesheet generation component operative to generate the stylesheet from the configuration file and an application-specific file, the application-specific file comprising one or more document rules specific to the translation of a particular type of document, the one or more of the generated conversion rules comprising a synthesis of one or more of the document rules and one or more of the settings defining the formatting standard.

4. The apparatus of claim 2, the one or more settings comprising settings for one or more of page size, font size, date format, calendar type, and reading direction.

5. The apparatus of claim 1, the stylesheet generation component operative to generate the stylesheet from the configuration file and a correction file, the correction file comprising one or more correction rules specific to the translation of a particular document of the one or more documents.

6. The apparatus of claim 1, comprising a selection component operative to select the configuration file from a plurality of configuration files, the plurality of configuration files each specific to a particular formatting standard, the configuration file selected as being the formatting standard for a particular culture.

7. The apparatus of claim 6, comprising a text extraction component operative to extract text from the one or more documents for translation to a language corresponding to the particular culture, the text extraction component operative to ignore attributes of the one or more documents that the stylesheet generation component is operative to convert.

8. The apparatus of claim 1, the one or more documents comprising a plurality of templates.

9. A method comprising:
selecting a configuration file from a plurality of configuration files, the plurality of configuration files each specific to a particular formatting standard, the configuration file selected as being a formatting standard for a particular culture, the configuration file comprising one or more settings defining the formatting standard; and
generating a stylesheet from the configuration file, the stylesheet comprising one or more conversion rules for the conversion of one or more documents to the formatting standard.

10. The method of claim 9, comprising generating the stylesheet from the configuration file and an application-specific file, the application-specific file comprising one or more document rules specific to the translation of a particular type of document, one or more of the generated conversion rules comprising a synthesis of one or more of the document rules and one or more of the settings defining the formatting standard.

11. The method of claim 9, the one more settings comprising settings for one or more of page size, font size, date format, calendar type, and reading direction.

12. The method of claim 9, comprising generating the stylesheet from the configuration file and a correction file, the correction file comprising one or more correction rules specific to the translation of a particular document of the one or more documents.

13. The method of claim 12, comprising extracting text from the one or more documents for translation to a language corresponding to the particular culture, the extraction ignoring attributes of the one or more documents that one or more conversation rules are operative to convert.

14. The method of claim 9, the one or more documents comprising a plurality of templates.

15. An article of manufacture comprising a storage medium containing instructions that when executed enable a system to:
generate a stylesheet from a configuration file, the configuration file comprising one or more settings defining a formatting standard, the stylesheet comprising one or more conversion rules for the conversion of one or more documents to the formatting standard; and
extract text from the one or more documents for translation to a language corresponding to a particular culture, the extraction ignoring attributes of the one or more documents that one or more conversation rules are operative to convert.

16. The apparatus of claim 15, the stylesheet generation component operative to generate the stylesheet from the configuration file and an application-specific file, the application-specific file comprising one or more document rules specific to the translation of a particular type of document, one or more of the generated conversion rules comprising a synthesis of one or more of the document rules and one or more of the settings defining the formatting standard.

17. The apparatus of claim 15, the one more settings comprising settings for one or more of page size, font size, date format, calendar type, and reading direction.

18. The apparatus of claim 15, the stylesheet generation component operative to generate the stylesheet from the configuration file and a correction file, the correction file comprising one or more correction rules specific to the translation of a particular document of the one or more documents.

19. The apparatus of claim 15, the stylesheet generation component operative to select the configuration file from a plurality of configuration files, the plurality of configuration files each specific to a particular formatting standard, the configuration file selected as being the formatting standard for the particular culture.

20. The apparatus of claim 15, the one or more documents comprising a plurality of templates.
